(19) United States
(12) Patent Application Publication
(10) Pub. No.: US 2013/0246833 A1
(43) Pub. Date: Sep. 19, 2013

(54) CLOCK GENERATOR AND INFORMATION PROCESSING APPARATUS

(71) Applicant: Kimihiro FUKUSHIMA, Kanagawa (JP)

(72) Inventor: Kimihiro FUKUSHIMA, Kanagawa (JP)

(73) Assignee: RICOH COMPANY, LTD., Tokyo (JP)

(21) Appl. No.: 13/790,446

(22) Filed: Mar. 8, 2013

(30) Foreign Application Priority Data
Mar. 19, 2012 (JP) 2012-062789

(51) Int. Cl. G06F 1/06

(52) U.S. Cl. CPC G06F 1/06
USPC 713/500

(57) ABSTRACT

A clock generator includes a first clock generating unit configured to generate a first clock signal based on a system clock signal, a second clock generating unit configured to generate a second clock signal with a frequency higher than the frequency of the first clock signal based on the system clock signal, a counting unit configured to count the number of clock pulses of the second clock signal in a cycle of the first clock signal, and an adjusting unit configured to adjust a falling edge or a rising edge of the second clock signal to synchronize with a falling edge or a rising edge of the first clock signal based on an assert signal that is output when the number of clock pulses of the second clock signal counted by the counting unit reaches a predetermined value.

### CROSS-REFERENCE TO RELATED APPLICATION

The present application is based upon and claims the benefit of priority of Japanese Patent Application No. 2012-062789, filed on Mar. 19, 2012, the entire contents of which are incorporated herein by reference.

### BACKGROUND OF THE INVENTION

1. Field of the Invention

An aspect of this disclosure relates to a clock generator and an information processing apparatus.

2. Description of the Related Art

Digital audio data is increasingly used in various apparatuses. For example, in a multifunction peripheral (MFP), digital audio data is used to provide voice guidance, output an error sound, and start and stop a printing process using a microphone. As another example, a video with sound is played on a projector. In such an apparatus, for example, an audio controller for sending and receiving audio data is provided in an application specific integrated circuit (ASIC) and connected to a codec device for AD/DA conversion to input and output audio via a microphone and a speaker.

FIG. 1 is a drawing illustrating a related-art digital transfer format known as I2S (Inter-IC sound bus) that is a standard digital transfer format for transferring audio data between an audio controller and a codec device.

As illustrated in FIG. 1, I2S includes three signals: an LRCLK signal, a BCLK (bit clock) signal, and a data (serial data) signal. The LRCLK signal is a clock signal having a sampling frequency and is used to identify a left channel and a Right channel. The BCLK signal is used to identify and extract respective bits. The data signal is used to serially transfer audio data.

The LRCLK signal, the BCLK signal, and the data signal need to be synchronized with each other. The start position of effective data (i.e., most significant bit (MSB)) is determined by the number of counts of the BCLK signal from a change point of the LRCLK signal. Therefore, the rising edge and the falling edge of the LRCLK signal need to be synchronized with the falling edge of the BCLK signal. In the example of FIG. 1, the effective bit width (the number of bits from the MSB to the LSB (least significant bit)) of the data signal is 16 bits.

The LRCLK signal is a clock signal having a specific sampling frequency and is used to determine a sampling rate. Therefore, the frequency of the LRCLK signal is determined according to various standards. For example, the frequency of the LRCLK signal is set at 44.1 kHz for a compact disk (CD) and set at 48 kHz or 96 kHz for a digital versatile disk (DVD) and a Blu-ray disk.

A typical audio controller uses a clock frequency that is 2ⁿ times greater than the sampling frequency to generate the LRCLK signal and the BCLK signal. For example, when the LRCLK signal is generated at a sampling frequency of 44.1 kHz defined in a standard, the BCLK signal is generated at a master clock frequency of 22.579 MHz that is 512 times greater than 44.1 kHz so that the LRCLK signal and the BCLK signal are synchronized with each other.

However, when, for example, an audio controller supports two sampling frequencies of 44.1 kHz and 48 kHz, it is necessary to supply plural master clock signals corresponding to the sampling frequencies. Accordingly, in this case, it is necessary to provide plural crystal oscillators for generating the master clock signals and this in turn increases the costs of an apparatus.

According to a known method, to prevent the above problem, a high-frequency master clock signal with a frequency of, for example, 1 GHz (which is not necessarily a multiple of the sampling frequency) is supplied, and the LRCLK signal and the BCLK signal are turned on and off according to counts of master clock pulses to obtain desired clock frequencies. With this method, since the LRCLK signal and the BCLK signal are generated by comparing counts of master clock pulses with register values, it is possible to generate the LRCLK signal and the BCLK signal based on any sampling frequency.

Also, Japanese Patent No. 4128067 discloses a method of generating a system clock signal corresponding to a given sampling rate where a mask signal is used to thin out system clock pulses according to the count of system clock pulses in one cycle of the LRCLK signal.

With the related-art methods described above, however, the power consumption increases because it is necessary to supply a high-frequency master clock signal to generate the LRCLK signal and the BCLK signal. For this reason, it is preferable to use a low-frequency master clock signal instead of a high-frequency master clock signal (e.g., 1 GHz) as described above. However, a counting method using a low-frequency master clock signal has at least one problem as described below.

FIG. 2 is a drawing used to describe a related-art counting method using a low-frequency master clock signal. In the example of FIG. 2, it is assumed that a half cycle of the LRCLK signal counted by an LR-clock frequency divider register is 756 master clock pulses, and one cycle of the BCLK signal counted by a B-clock frequency divider register is 10 master clock pulses.

Here, even when the LRCLK signal is generated at a sampling frequency defined in a standard such that the rising edge of the LRCLK signal is synchronized with the falling edge of the BCLK signal as indicated by an arrow (1) in FIG. 2, the falling edge of the LRCLK signal is not synchronized with the falling edge of the BCLK signal.

Meanwhile, it is possible to synchronize the LRCLK signal with the BCLK signal by using a method where the BCLK signal is generated by a counting method and the LRCLK signal is generated based on a 1/n cycle of the BCLK signal. With this method, however, it is not possible to generate the LRCLK signal at sampling frequencies defined in various standards.

### SUMMARY OF THE INVENTION

In an aspect of this disclosure, there is provided a clock generator that includes a first clock generating unit configured to generate a first clock signal based on a system clock signal, a second clock generating unit configured to generate a second clock signal with a frequency higher than the frequency of the first clock signal based on the system clock signal, a counting unit configured to count the number of clock pulses of the second clock signal in a cycle of the first clock signal, and an adjusting unit configured to adjust a falling edge or a rising edge of the second clock signal to synchronize with a falling edge or a rising edge of the first clock signal based on an assert signal that is output when the number of clock pulses of the second clock signal counted by the counting unit reaches a predetermined value.

### BRIEF DESCRIPTION OF THE DRAWINGS

FIG. 1 is a drawing illustrating a related-art digital transfer format;

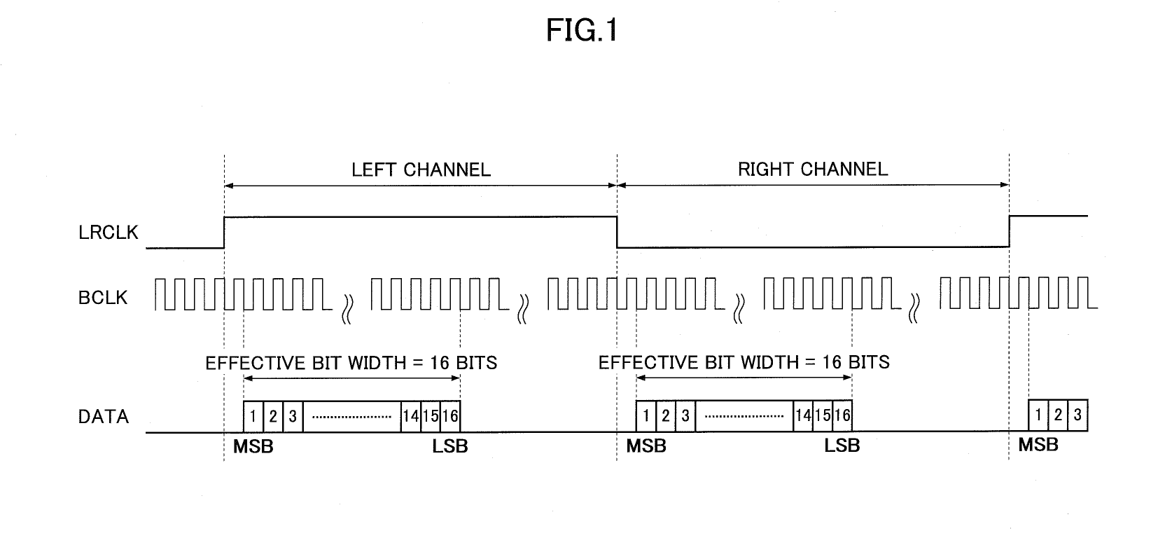

FIG. 2 is a drawing used to describe a related-art counting method using a low-frequency master clock signal;

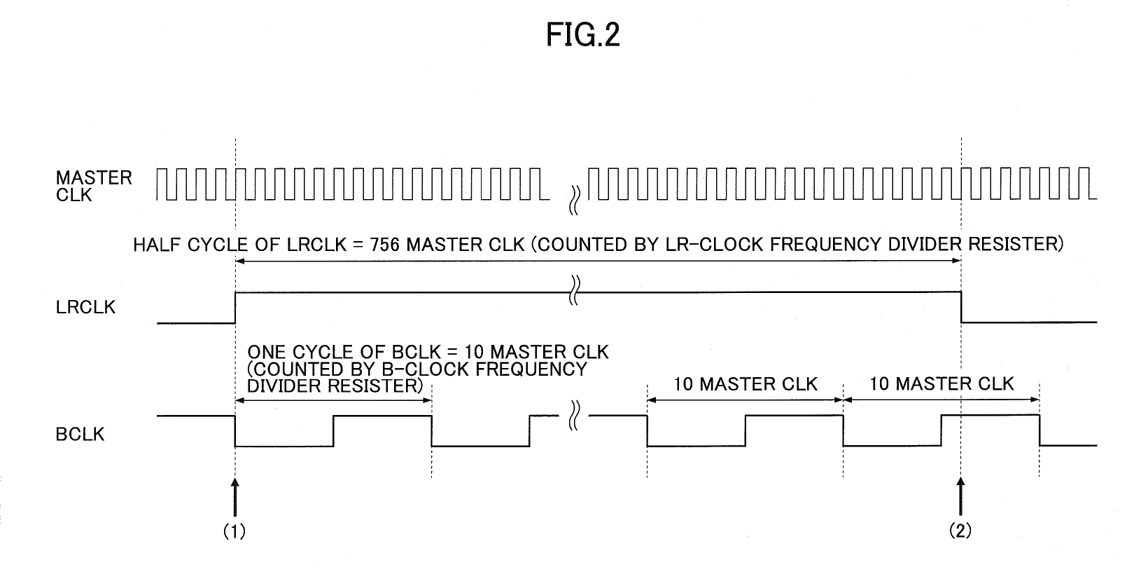

FIG. 3 is block diagram illustrating an exemplary circuit configuration of an audio controller according to an embodiment;

FIG. 4 is a timing chart used to describe an exemplary process of generating LRCLK;

FIG. 5 is a flowchart illustrating an exemplary process of generating LRCLK;

FIG. 6 is a timing chart used to describe an exemplary process of generating BCLK;

FIG. 7 is a timing chart used to describe operations of a BCLK number counter;

FIG. 8 is a timing chart used to describe an exemplary process of generating a last clock pulse of BCLK;

FIG. 9 is a flowchart illustrating an exemplary process of generating BCLK;

FIG. 10 is a timing chart used to describe an entire process of generating clock signals;

FIG. 11 is a drawing illustrating audio data transferred in an I2S format;

FIG. 12 is a drawing illustrating audio data transferred in a left-justified format;

FIG. 13 is a drawing illustrating audio data transferred in a right-justified format; and

FIG. 14 is a drawing illustrating audio data transferred with a reduced number of BCLK clock pulses.

### DESCRIPTION OF THE PREFERRED EMBODIMENTS

Preferred embodiments of the present invention are described below with reference to the accompanying drawings.

### <Circuit Configuration of Audio Controller>

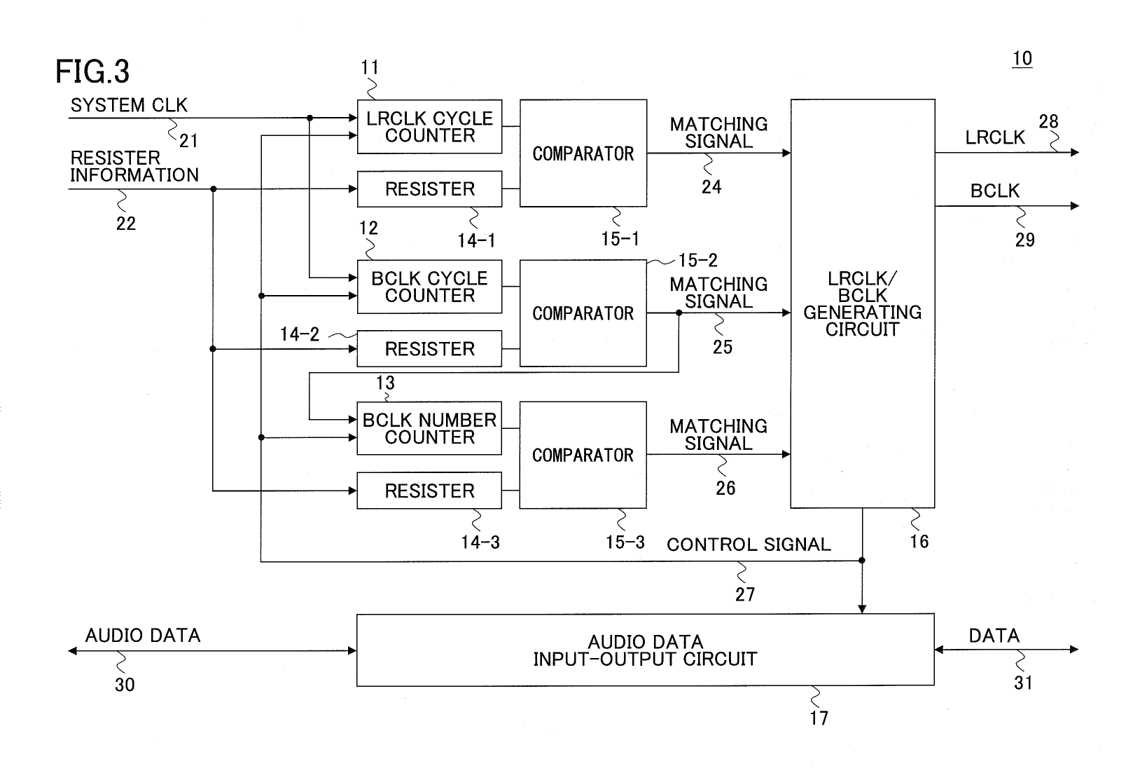

FIG. 3 is block diagram illustrating an exemplary circuit configuration of an audio controller 10 according to an embodiment. As illustrated in FIG. 3, the audio controller 10 may include an LRCLK cycle counter 11, a BCLK cycle counter 12, a BCLK number counter 13, registers 14-1 through 14-3, comparators 15-1 through 15-3, an LRCLK/BCLK generating circuit 16, and an audio data input-output circuit 17. The circuit configuration of FIG. 3 may be described, for example, by a hardware description language (HDL).

The LRCLK cycle counter 11 receives a system CLK (system clock signal) 21 and counts the number of clock pulses (or cycles) of the system CLK 21.

The register 14-1 stores a parameter (first register value) that is received as register information 22 and used to determine the cycle of an LRCLK (LR clock signal) 28 used as a first clock signal.

The comparator 15-1 compares a counter value output from the LRCLK cycle counter 11 with the first register value obtained from the register 14-1. When the counter value matches the first register value, the comparator 15-1 asserts a matching signal 24 and outputs the matching signal 24 to the LRCLK/BCLK generating circuit 16.

The BCLK cycle counter (system clock counting unit) 12 receives the system CLK 21 and counts the number of clock pulses (or cycles) of the system CLK 21.

The register 14-2 stores a parameter (second register value) that is received as the register information 22 and used to determine the cycle of a BCLK (bit clock signal) 29 used as a second clock signal.

The comparator 15-2 compares a counter value output from the BCLK cycle counter 12 with the second register value obtained from the register 14-2. When the counter value matches the second register value, the comparator 15-2 asserts a matching signal 25 and outputs the matching signal 25 to the LRCLK/BCLK generating circuit 16 and the BCLK number counter 13.

The system CLK 21 is, for example, a clock signal with a frequency of 66.66 MHz or 133.33 MHz. The system CLK 21 may be the same as a clock signal used when sending and receiving audio data 30 between the audio data input-output circuit 17 and a storage unit connected to the audio data input-output circuit 17. In other words, the frequency of the system CLK 21 may be determined based on the frequency of the clock signal used when sending and receiving audio data 30 between the audio data input-output circuit 17 and the storage unit.

The BCLK number counter (counting unit) 13 receives the matching signal 25. The BCLK number counter counts the matching signal 25 when the BCLK 29 is turned on (high) and thereby counts the number of clock pulses (or cycles) of the BCLK 29.

The register 14-3 stores a number parameter (third register value) that is received as the register information 22 and used to determine the number of clock pulses of the BCLK 29. The number parameter indicates, for example, the number of clock pulses of the BCLK 29 in a half cycle of the LRCLK 28 (i.e., a ½ cycle of the sampling period).

The comparator 15-3 compares a counter value output from the BCLK number counter 13 with the third register value obtained from the register 14-3. When the counter value matches the third register value, the comparator 15-3 asserts a matching signal (assert signal) 26 and outputs the matching signal 26 to the LRCLK/BCLK generating circuit 16.

The LRCLK/BCLK generating circuit 16 generates the LRCLK 28 based on the matching signal 24 input from the comparator 15-1. More specifically, the LRCLK/BCLK generating circuit 16 generates the LRCLK 28 as a clock signal that is repeatedly turned on (high) and off (low) based on the assert timing of the matching signal 24. Thus, the LRCLK/BCLK generating circuit 16 generates the LRCLK 28 with a cycle that is based on the first register value set in the register 14-1.

The LRCLK/BCLK generating circuit 16 also generates the BCLK 29 based on the matching signal 25 input from the comparator 15-2. More specifically, the LRCLK/BCLK generating circuit 16 generates the BCLK 29 as a clock signal that is repeatedly turned on (high) and off (low) based on the assert timing of the matching signal 25. Thus, the LRCLK/BCLK generating circuit 16 generates the BCLK 29 with a cycle that is based on the second register value set in the register 14-2. The BCLK 29 has a frequency higher than that of the LRCLK 28.

When the matching signal 26 is input, the LRCLK/BCLK generating circuit 16 adjusts the falling edge or the rising edge of the BCLK 29 to synchronize with the falling edge or the rising edge of the LRCLK 28. This adjustment process is described later in detail.

The audio data input-output circuit (output unit) 17 reads the audio data 30 from the storage unit connected to the audio data input-output circuit 17, and outputs data 31 in synchronization with the BCLK 29 provided from the LRCLK/BCLK generating circuit 16 according to a data transfer format such as an I2S format, a left-justified format, or a right-justified format.

Also, the audio data input-output circuit 17 writes the data 31, which is input in a data transfer format such as the I2S format, the left-justified format, or the right-justified format and synchronized with the BCLK 29, as the audio data 30 into the storage unit connected to the audio data input-output circuit 17.

The LRCLK cycle counter 11, the BCLK cycle counter 12, the BCLK number counter 13, the registers 14-1 through 14-3, the comparators 15-1 through 15-3, and the LRCLK/BCLK generating circuit 16 correspond to a clock generator.

The LRCLK cycle counter 11, the register 14-1, the comparator 15-1, and a part of the LRCLK/BCLK generating circuit 16 correspond to a first clock generating unit; and the BCLK cycle counter 12, the register 14-2, the comparator 15-2, and a part of the LRCLK/BCLK generating circuit 16 correspond to a second clock generating unit. Also, the LRCLK/BCLK generating circuit 16 corresponds to an adjusting unit.

The above configuration of the present embodiment makes it possible to generate the LRCLK 28 and the BCLK 29 with predetermined frequencies based on the number of clock pulses of the system CLK 21. The above configuration also makes it possible to adjust the falling edge of a clock pulse of the BCLK 29 to synchronize with the rising edge or the falling edge of the LRCLK 28.

### <Process of Generating LRCLK>

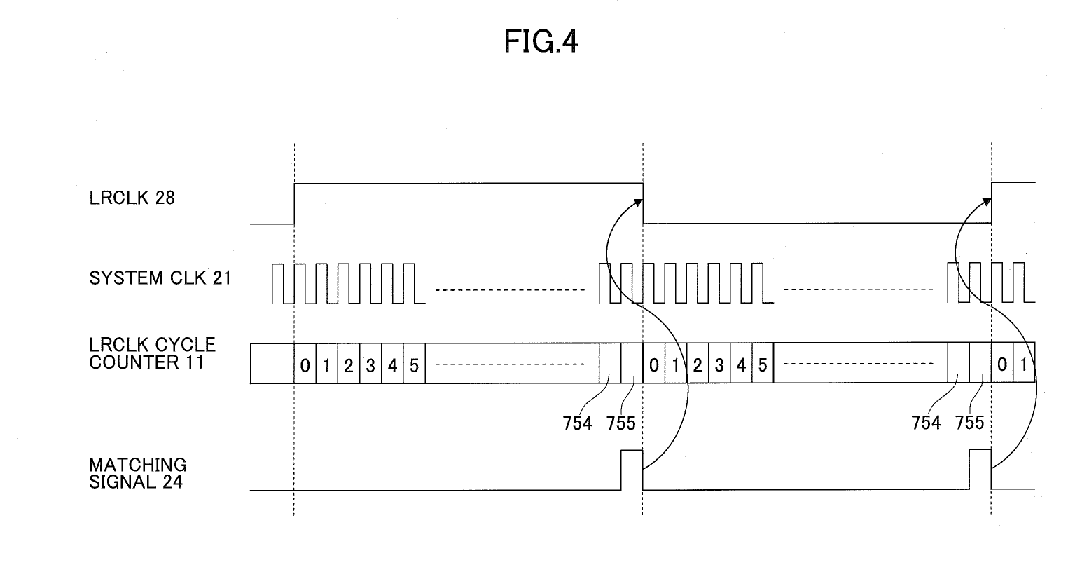

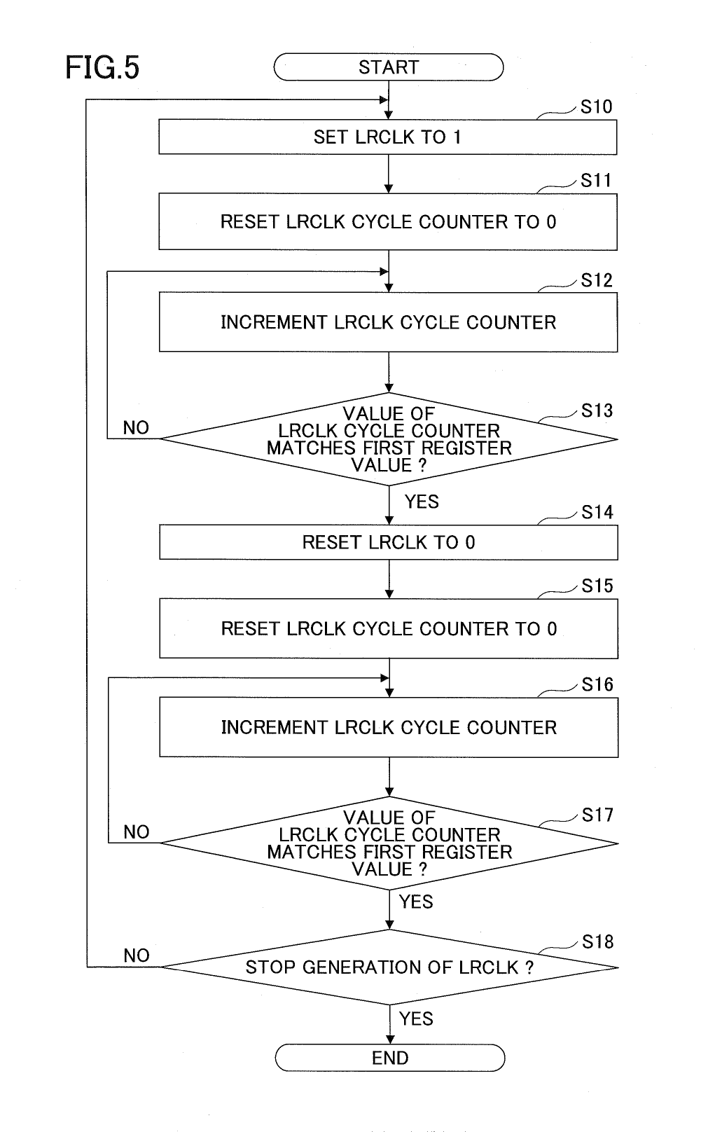

An exemplary process of generating the LRCLK 28 is described below. FIG. 4 is a timing chart used to describe an exemplary process of generating the LRCLK 28. FIG. 5 is a flowchart illustrating an exemplary process of generating the LRCLK 28.

In the present embodiment, it is assumed that the LRCLK 28 is generated at a frequency (sampling frequency) of 44.1 kHz and the input signal frequency of the system CLK 21 is 66.666 MHz. However, these frequencies are just examples, and any other frequencies may be used. For example, the frequency of the LRCLK 28 may be determined according a sound source such as a DVD or a Blu-ray disk.

When the exemplary frequencies described above are used, the number of clock pulses of the system CLK 21 in a half cycle of the LRCLK 28 is 756. Accordingly, when the counter value, which starts from 0, of the LRCLK cycle counter 11 becomes 755, the matching signal 24 is input to the LRCLK/BCLK generating circuit 16.

As illustrated in FIG. 4, when generating the LRCLK 28, the LRCLK/BCLK generating circuit 16 turns on (high) the LRCLK 28 in synchronization with a rise of the system CLK 21 and resets the counter value of the LRCLK cycle counter 11 to 0.

When the matching signal 24 is input according to the counter value of the LRCLK cycle counter 11, the LRCLK/BCLK generating circuit 16 turns off (low) the LRCLK 28. Then, when the next matching signal 24 is input according to the counter value of the LRCLK cycle counter 11, the LRCLK/BCLK generating circuit 16 turns on (high) the LRCLK 28.

The above process is described in more detail with reference to FIG. 5. When starting generation of the LRCLK 28, the LRCLK/BCLK generating circuit 16 sets the LRCLK 28 to 1 (high) in synchronization with a rise of the system CLK 21 (S10).

At the same time, the LRCLK/BCLK generating circuit 16 resets the LRCLK cycle counter 11 to 0 by outputting a control signal 27 (S11).

Each time when the LRCLK cycle counter 11 is incremented at the rise of the system CLK 21 (S12), the comparator 15-1 determines whether the counter value of the LRCLK cycle counter 11 matches the register value (first register value) of the register 14-1 (S13).

In the present embodiment, as described above, it is assumed that the LRCLK 28 is generated at a frequency of 44.1 kHz and the frequency of the system CLK 21 is 66.666 MHz. Based on this assumption, the number of clock pulses of the system CLK 21 corresponding to a half cycle of the LRCLK 28 is “66.66 MHz/(44.1 kHz×2) 756”. Since the LRCLK cycle counter 11 starts counting from 0, 756 is represented by “756−1=755”. Accordingly, the first register value “755” is stored beforehand in the register 14-1 as a comparison parameter.

When the counter value of the LRCLK cycle counter 11 matches the first register value (YES at S13), the comparator 15-1 asserts the matching signal 24 and outputs the matching signal 24 to the LRCLK/BCLK generating circuit 16. Meanwhile, when the counter value of the LRCLK cycle counter 11 does not match the first register value (NO at S13), the process returns to step S12.

When the matching signal 24 is input, the LRCLK/BCLK generating circuit 16 resets the LRCLK 28 to 0 (low) (S14). Also, the LRCLK/BCLK generating circuit 16 resets the LRCLK cycle counter 11 to 0 by outputting the control signal 27 (S15).

Then, each time when the LRCLK cycle counter 11 is incremented at the rise of the system CLK 21 (S16), the comparator 15-1 determines whether the counter value of the LRCLK cycle counter 11 matches the first register value (S17).

When the counter value of the LRCLK cycle counter 11 matches the first register value (YES at S17), the comparator 15-1 asserts the matching signal 24 and outputs the matching signal 24 to the LRCLK/BCLK generating circuit 16. Meanwhile, when the counter value of the LRCLK cycle counter 11 does not match the first register value (NO at S17), the process returns to step S16. Through the above process, one cycle of the LRCLK 28 is generated.

Then, the LRCLK/BCLK generating circuit 16 determines whether to stop generation of the LRCLK 28 (S18). When the LRCLK/BCLK generating circuit 16 determines to not stop generation of the LRCLK 28 (NO at S18), the process returns to step S10. Meanwhile, when the LRCLK/BCLK generating circuit 16 determines to stop generation of the LRCLK 28 (YES at S18), the process is terminated.

Thus, the LRCLK 28 is generated at a predetermined frequency based on the number of clock pulses of the system CLK 21.

### <Process of Generating BCLK>

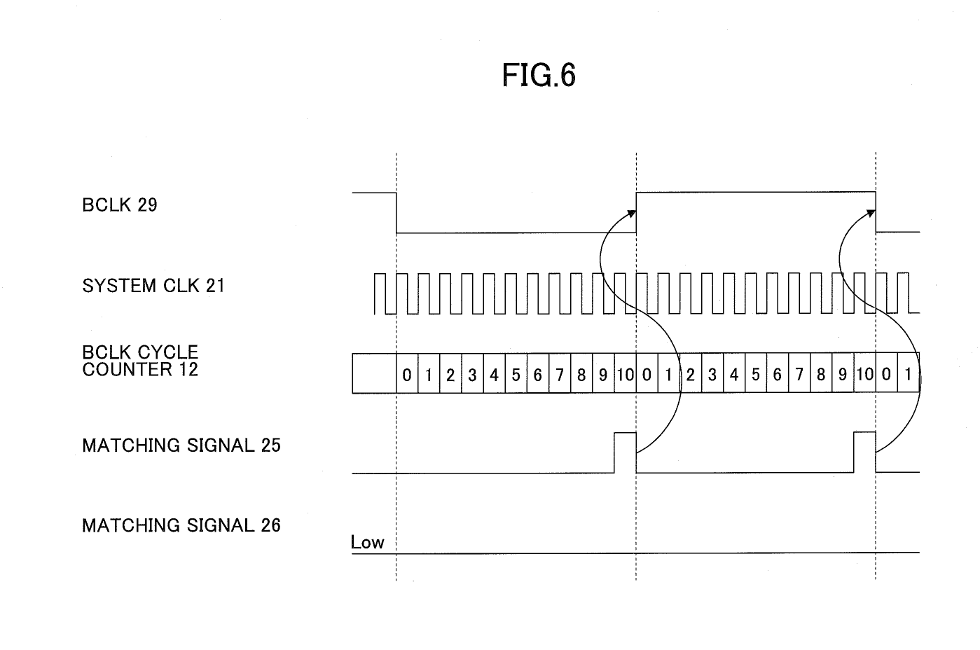

An exemplary process of generating the BCLK 29 is described below. FIG. 6 is a timing chart used to describe an exemplary process of generating the BCLK 29.

In the present embodiment, it is assumed that the LRCLK 28 is generated at a frequency of 44.1 kHz, the input signal frequency of the system CLK 21 is 66.666 MHz, and the number of clock pulses of the BCLK 29 in a half cycle of the LRCLK 28 is 32. However, these values are just examples, and any other values may be used.

Based on the above assumption, the frequency of the BCLK 29 becomes 3.03 MHz, and the number of clock pulses of the system CLK 21 corresponding to a half cycle of the BCLK 29 becomes 11. Accordingly, when the counter value, which starts from 0, of the BCLK cycle counter 12 becomes 10, the matching signal 25 is input to the LRCLK/BCLK generating circuit 16.

As illustrated in FIG. 6, in generating the BCLK 29, the LRCLK/BCLK generating circuit 16 turns off (low) the BCLK 29 in synchronization with a rise of the system CLK 21 and resets the counter value of the BCLK cycle counter 12 to 0.

When the matching signal 25 is input according to the counter value of the BCLK cycle counter 12, the LRCLK/BCLK generating circuit 16 turns on (high) the BCLK 29. Then, when the next matching signal 25 is input according to the counter value of the BCLK cycle counter 12, the LRCLK/BCLK generating circuit 16 turns off (low) the BCLK 29. During this process, the matching signal 26 is kept turned off (low).

Thus, the BCLK 29 is generated at a predetermined frequency based on the number of clock pulses of the system CLK 21.

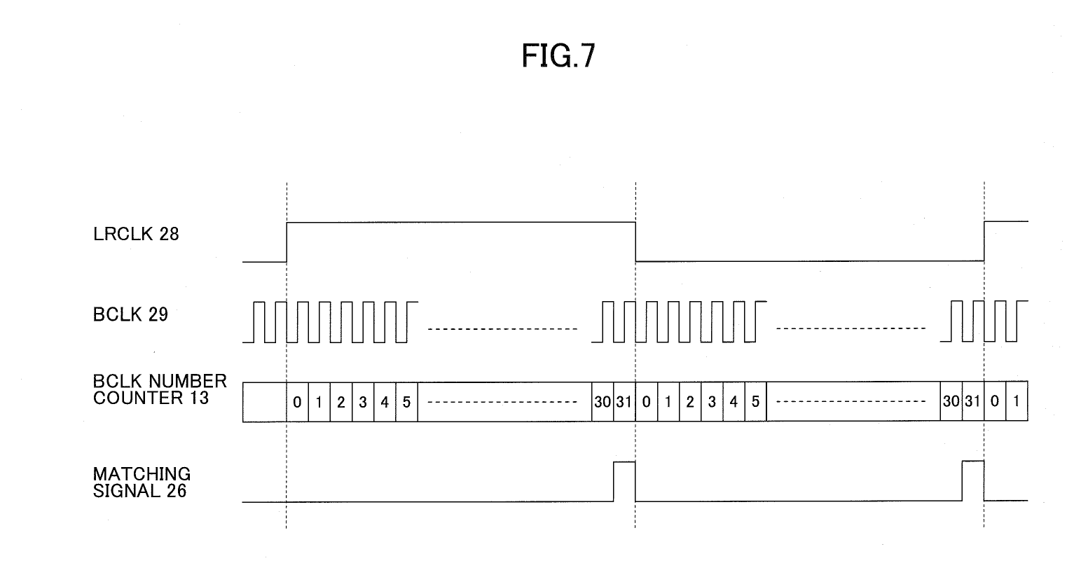

Next, the number of clock pulses of the BCLK 29 in a half cycle of the LRCLK 28 is described below. FIG. 7 is a timing chart used to describe operations of the BCLK number counter 13.

In the present embodiment, it is assumed that the number of clock pulses of the BCLK 29 in a half cycle of the LRCLK 28 is 32. However, this value is just an example and any other value may be used. For example, the number of clock pulses of the BCLK 29 in a half cycle of the LRCLK 28 may be set at any value such as 48 or 64 depending on a device to which the BCLK 29 is to be input. When the number of clock pulses of the BCLK 29 in a half cycle of the LRCLK 28 is changed, the frequency of the BCLK 29 is also changed.

As illustrated in FIG. 7, when the counter value, which starts from 0, of the BCLK number counter 13 becomes 31 in a half cycle of the LRCLK 28, the matching signal 26 is input to the LRCLK/BCLK generating circuit 16. That is, when the last clock pulse of the BCLK 29 generated immediately before the falling edge or the rising edge of the LRCLK 28 is counted, the matching signal is input to the LRCLK/BCLK generating circuit 16.

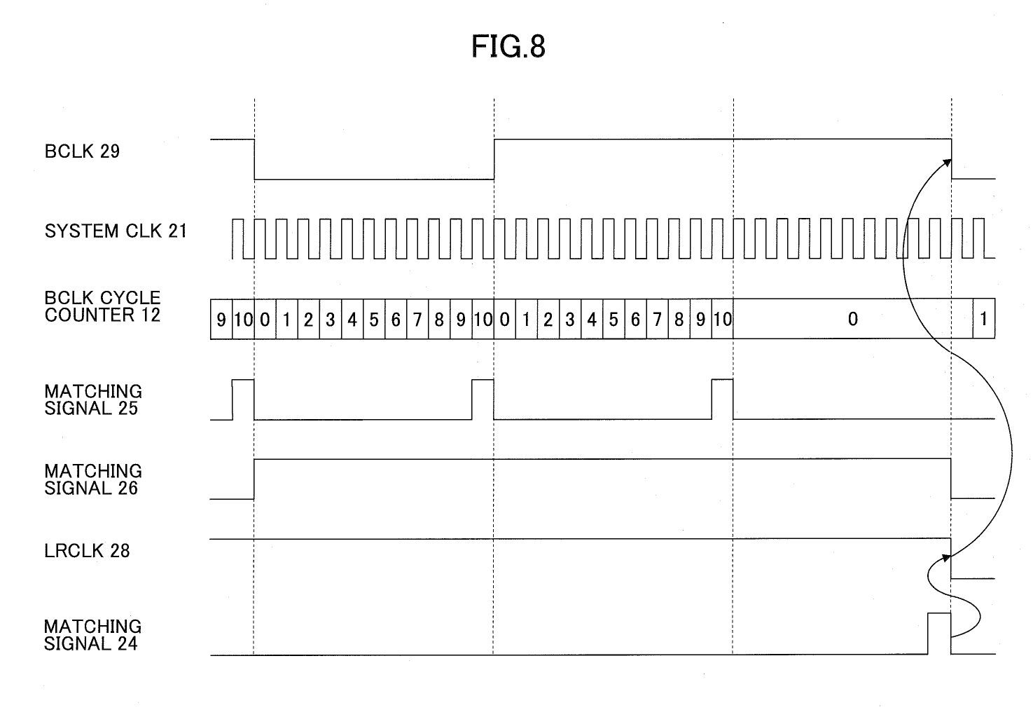

Next, an exemplary process of generating the last clock pulse of the BCLK 29 is described with reference to a timing chart of FIG. 8.

As illustrated in FIG. 8, the BCLK 29 falls in response to the matching signal 25 and the matching signal 26 indicating the last clock pulse of the BCLK 29 in a half cycle of the LRCLK 28 is input to the LRCLK/BCLK generating circuit 16. When a first matching signal 25 is input while the matching signal 26 is asserted, the LRCLK/BCLK generating circuit 16 turns on (high) the BCLK 29 to generate the last clock pulse and keeps the BCLK 29 turned on even when a second matching signal 25 is input.

Then, when the matching signal 24 indicating a change point (which is the falling edge in the example of FIG. 8) is input, the LRCLK/BCLK generating circuit 16 causes the falling edge of the last clock pulse of the BCLK 29 to synchronize with the falling edge of the LRCLK 28.

Thus, the LRCLK/BCLK generating circuit 16 adjusts the width of the last clock pulse of the BCLK 29 to cause the falling edge of the last clock pulse of the BCLK 29 to synchronize with the falling edge of the LRCLK 28.

As described above, the LRCLK/BCLK generating circuit 16 can cause the falling edge or the rising edge of the last clock pulse of the BCLK 29 to synchronize with the rising edge or the falling edge of the LRCLK 28.

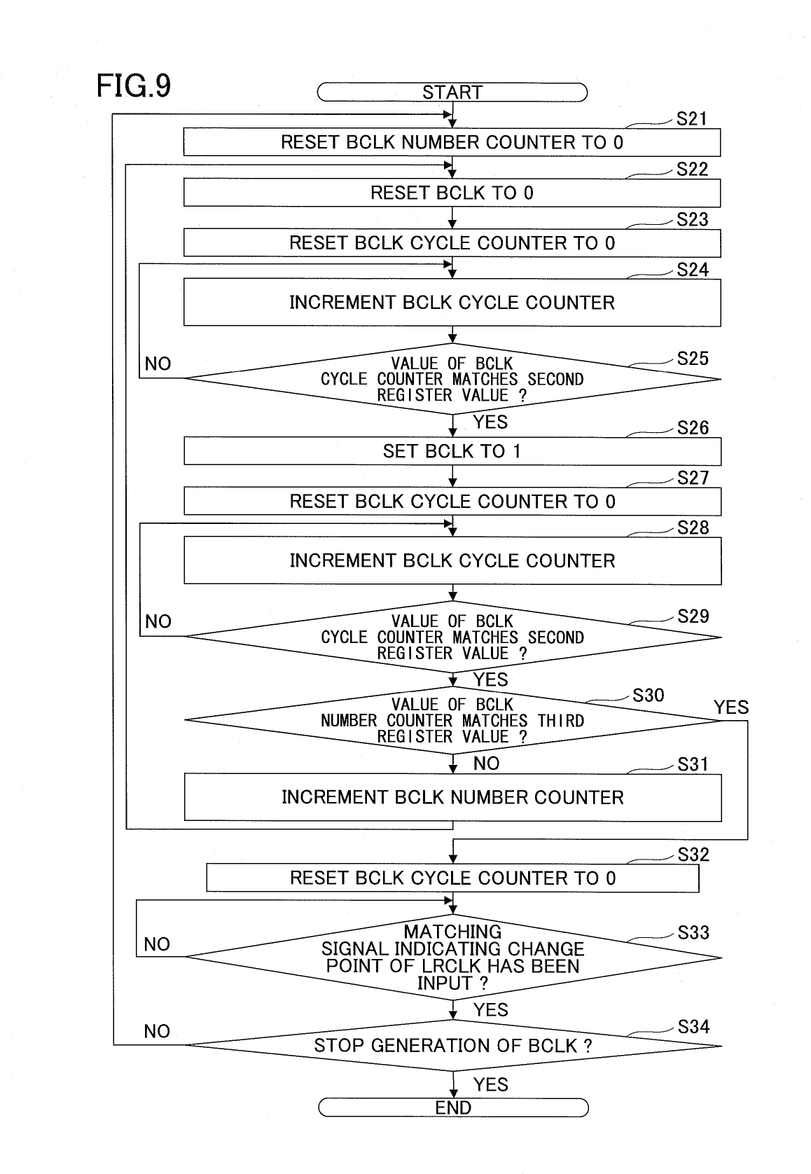

An exemplary process of generating the BCLK 29 is described below with reference to a flowchart of FIG. 9.

As illustrated in FIG. 9, when starting generation of the BCLK 29, the LRCLK/BCLK generating circuit 16 outputs the control signal 27 to reset the BCLK number counter 13 to 0 (S21), and resets the BCLK 29 to 0 (low) in synchronization with a rise of the system CLK 21 (S22). Here, it is assumed that when generation of the BCLK 29 is started, the BCLK 29 is reset to 0 in synchronization with the rise of the LRCLK 28 at the start of generation of the LRCLK 28.

At the same time, the LRCLK/BCLK generating circuit 16 resets the BCLK cycle counter 12 to 0 by outputting the control signal 27 (S23).

Each time when the BCLK cycle counter 12 is incremented at the rise of the system CLK 21 (S24), the comparator 15-2 determines whether the counter value of the BCLK cycle counter 12 matches the register value (second register value) of the register 14-2 (S25).

In the present embodiment, as described above, it is assumed that the frequency of the LRCLK 28 is 44.1 kHz, the number of clock pulses of the BCLK 29 in a half cycle of the LRCLK 28 is 32, and the frequency of the system CLK 21 is 66.666 MHz. Accordingly, the frequency of the BCLK 29 becomes 3.03 MHz. In this case, the number of clock pulses of the system CLK 21 in a half cycle of the BCLK 29 is “66.666 MHz/(3.03 MHz×2)≈11”. Since the BCLK cycle counter 12 starts counting from 0, 11 is represented by “11−1=10”. Accordingly, the second register value “10” is stored beforehand in the register 14-2 as a comparison parameter.

When the counter value of the BCLK cycle counter 12 matches the second register value (YES at S25), the comparator 15-2 asserts the matching signal 25 and outputs the matching signal 25 to the LRCLK/BCLK generating circuit 16. Meanwhile, when the counter value of the BCLK cycle counter 12 does not match the second register value (NO at S25), the process returns to step S24.

When the matching signal 25 is input, the LRCLK/BCLK generating circuit 16 sets the BCLK 29 to 1 (high) (S26). Also, the LRCLK/BCLK generating circuit 16 resets the BCLK cycle counter 12 to 0 by outputting the control signal 27 (S27).

Then, each time when the BCLK cycle counter 12 is incremented at the rise of the system CLK 21 (S28), the comparator 15-2 determines whether the counter value of the BCLK cycle counter 12 matches the second register value (S29).

When the counter value of the BCLK cycle counter 12 matches the second register value (YES at S29), the comparator 15-2 asserts the matching signal 25 and outputs the matching signal 25 to the LRCLK/BCLK generating circuit 16. Meanwhile, when the counter value of the BCLK cycle counter 12 does not match the second register value (NO at S29), the process returns to step S28. Through the above process, one cycle of the BCLK 29 is generated.

Next, the comparator 15-3 determines whether the counter value of the BCLK number counter 13 matches the register value (third register value) of the register 14-3 (S30). As described above, since the number of clock pulses of the BCLK 29 in a half cycle of the LRCLK 28 is set at 32 and the BCLK number counter 13 starts counting from 0, the third register value is “32−1=31”. The second register value “31” is stored beforehand in the register 14-3 as a comparison parameter.

When the counter value of the BCLK number counter 13 does not match the third register value (NO at S30), the BCLK number counter 13 is incremented (S31) and the process returns to step S22.

When the counter value of the BCLK number counter 13 matches the third register value (YES at S30), the comparator 15-3 asserts the matching signal 26 and outputs the matching signal 26 to the LRCLK/BCLK generating circuit 16.

When a first matching signal 25 is input while the matching signal 26 is turned on, the LRCLK/BCLK generating circuit 16 turns on (high) the BCLK 29 to generate the last clock pulse and keeps the BCLK 29 turned on even when a second matching signal 25 is input, and outputs the control signal 27 to reset the BLCK cycle counter 12 to 0 (S32). Thus, when the last clock pulse of the BCLK 29 is generated, the LRCLK/BCLK generating circuit 16 causes the BLCK cycle counter 12 to not count the clock pulses of the system CLK 21 for a predetermined period of time.

Next, the LRCLK/BCLK generating circuit 16 determines whether the matching signal 24 indicating a change point of the LRCLK 29 is input (S33).

When determining that the matching signal 24 is input (YES at S33), the LRCLK/BCLK generating circuit 16 turns off (low) the BCLK 29 such that the falling edge of the last clock pulse of the BCLK 29 synchronizes with the rising edge or the falling edge of the LRCLK 28. Meanwhile, when determining that the matching signal 24 is not input (NO at S33), the LRCLK/BCLK generating circuit 16 repeats step S33.

Then, the LRCLK/BCLK generating circuit 16 determines whether to stop generation of the BCLK 29 (S34). When the LRCLK/BCLK generating circuit 16 determines to not stop generation of the BCLK 29 (NO at S34), the process returns to step S21. Meanwhile, when the LRCLK/BCLK generating circuit 16 determines to stop generation of the BCLK 29 (YES at S34), the process is terminated.

As described above, the BCLK 29 is generated at a predetermined frequency based on the number of clock pulses of the system CLK 21. Also, the LRCLK/BCLK generating circuit 16 adjusts the width of the last clock pulse of the BCLK 29 by causing the BLCK cycle counter 12 to not count the clock pulses of the system CLK 21 for a predetermined period of time and thereby causes the falling edge or the rising edge of the last clock pulse of the BCLK 29 to synchronize with the falling edge or the rising edge of the LRCLK 28.

### <Overall Process of Generating Clock Signals>

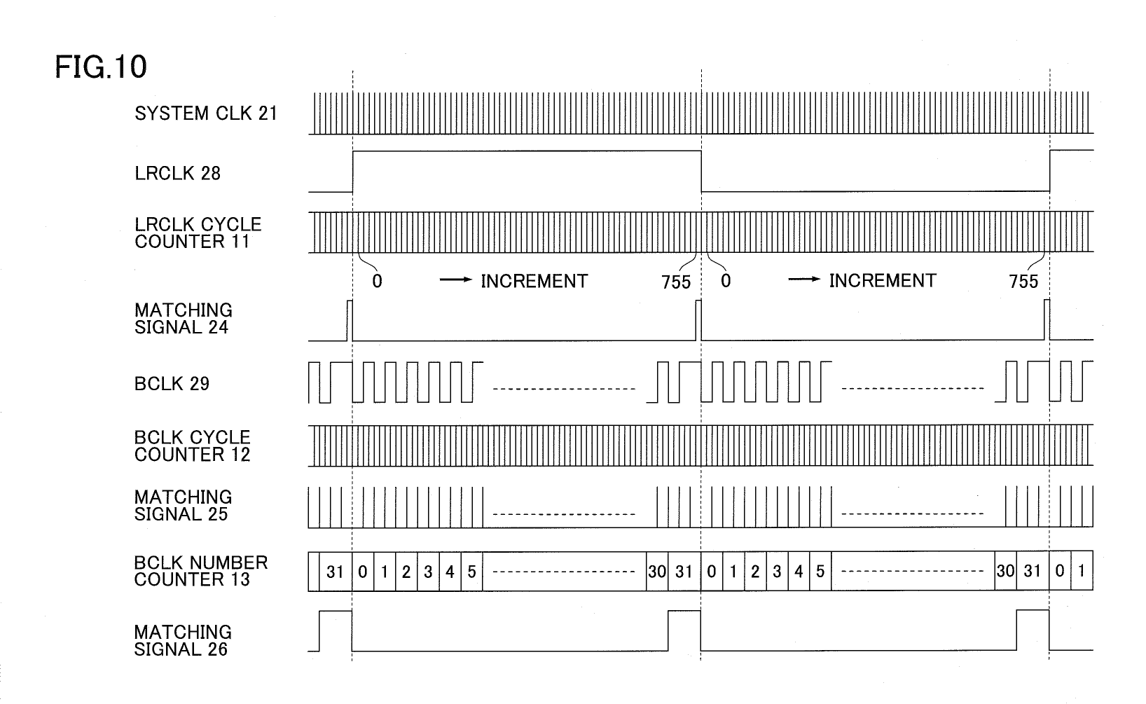

An example of an entire process of generating clock signals in the audio controller 10 is described below with reference to a timing chart of FIG. 10.

As illustrated in FIG. 10, the system CLK 21 is input to the audio controller 10. When the number of clock pulses of the system CLK 21 counted by the LRCLK cycle counter 11 reaches 755 that corresponds to a half cycle of the LRCLK 28, the matching signal 24 indicating a change point of the LRCLK 28 is input to the LRCLK/BCLK generating circuit 16.

When the matching signal 24 is input, the LRCLK/BCLK generating circuit 16 turns on (high) or off (low) the LRCLK 28.

Also, when the number of clock pulses of the system CLK 21 counted by the BCLK cycle counter 12 reaches 10 that corresponds to a half cycle of the BCLK 29, the matching signal 25 is input to the LRCLK/BCLK generating circuit 16. When the matching signal 25 is input, the LRCLK/BCLK generating circuit 16 turns on or off the BCLK 29.

When the number of clock pulses of the BCLK 29 counted by the BCLK number counter 13 reaches 31, the matching signal 26 indicating the last clock pulse of the BCLK 29 in a half cycle of the LRCLK 28 is input to the LRCLK/BCLK generating circuit 16.

When the matching signal 26 is input, the LRCLK/BCLK generating circuit 16 turns off (low) the BCLK 29; and when a first matching signal 25 is input while the matching signal 26 is turned on, the LRCLK/BCLK generating circuit 16 turns on (high) the BCLK 29 to generate the last clock pulse. The LRCLK/BCLK generating circuit 16 keeps the BCLK 29 turned on even when a second matching signal 25 is input and waits for the matching signal 24 indicating a change point of the LRCLK 28.

When the matching signal 24 is input, the LRCLK/BCLK generating circuit 16 adjusts the falling edge of the last clock pulse of the BCLK 29 to synchronize with the falling edge or the rising edge of the LRCLK 28.

As described above, the LRCLK/BCLK generating circuit 16 adjusts the width of the last clock pulse of the BCLK 29 by controlling the length of an on-period or an off-period of the BCLK 29 such that the falling edge of the last clock pulse is synchronized with a change point of the LRCLK 28.

### <Transfer of Audio Data in I2S Format>

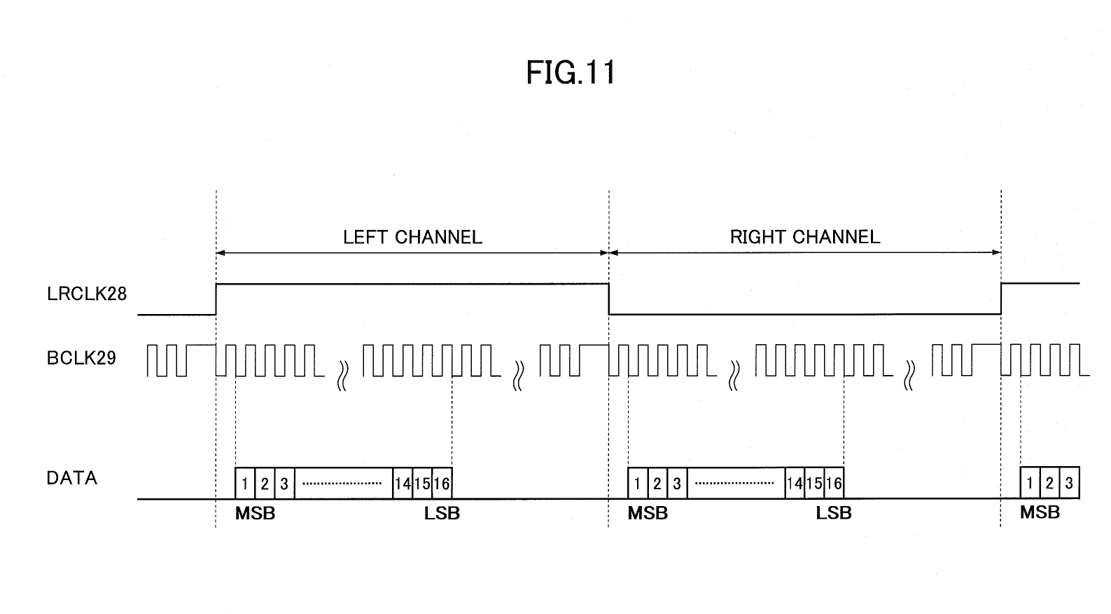

Next, transfer of audio data in an I2S format based on the LRCLK 28 and the BCLK 29 is described with reference to FIG. 11.

In the I2S format, as illustrated in FIG. 11, data needs to be output from the audio data input-output circuit 17 in synchronization with the BCLK 29 after one clock pulse of the BCLK 29, which is synchronized with the rising edge or the falling edge of the LRCLK 28, is generated.

In the present embodiment, the pulse width of last clock pulses of the BCLK 29 is adjusted so that the falling edges of the last clock pulses are synchronized with the corresponding rising and falling edges of the LRCLK 28. Therefore, data is also output in synchronization with the BCLK 29.

### <Transfer of Audio Data in Left-Justified Format>

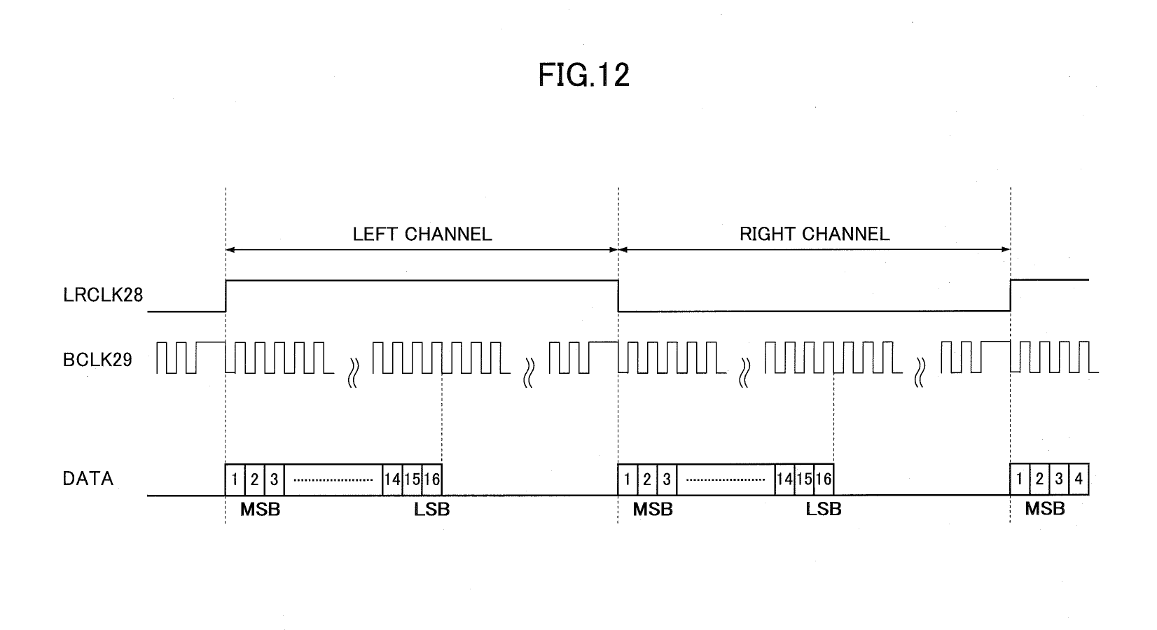

Next, transfer of audio data in a left-justified format based on the LRCLK 28 and the BCLK 29 is described with reference to FIG. 12.

In the left-justified format, as illustrated in FIG. 12, data needs to be output from the audio data input-output circuit 17 in synchronization with each of the rising edge and the falling edge of the LRCLK 28.

In the present embodiment, the pulse width of last clock pulses of the BCLK 29 is adjusted so that the falling edges of the last clock pulses are synchronized with the corresponding rising and falling edges of the LRCLK 28. Therefore, data is also output in synchronization with the BCLK 29.

### <Transfer of Audio Data in Right-Justified Format>

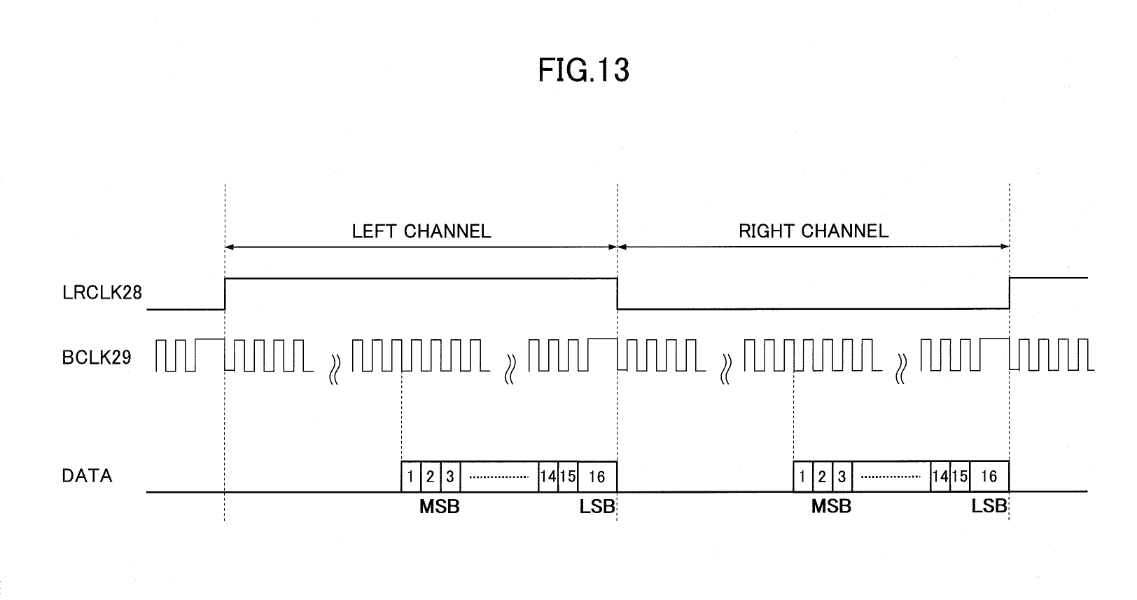

Next, transfer of audio data in a right-justified format based on the LRCLK 28 and the BCLK 29 is described with reference to FIG. 13.

In the right-justified format, as illustrated in FIG. 13, data needs to be output from the audio data input-output circuit 17 in synchronization with each of the falling edge and the rising edge of the LRCLK 28.

In the present embodiment, the pulse width of last clock pulses of the BCLK 29 is adjusted so that the falling edges of the last clock pulses are synchronized with the corresponding falling and rising edges of the LRCLK 28. Therefore, data is also output in synchronization with the BCLK 29. In the case of FIG. 13, the output width of audio data is also adjusted to match the adjusted pulse width of the last clock pulse of the BCLK 29 so that the synchronization of the audio data with the BCLK 29 is maintained.

<Transfer of Audio Data with Reduced Number of BCLK Clock Pulses>

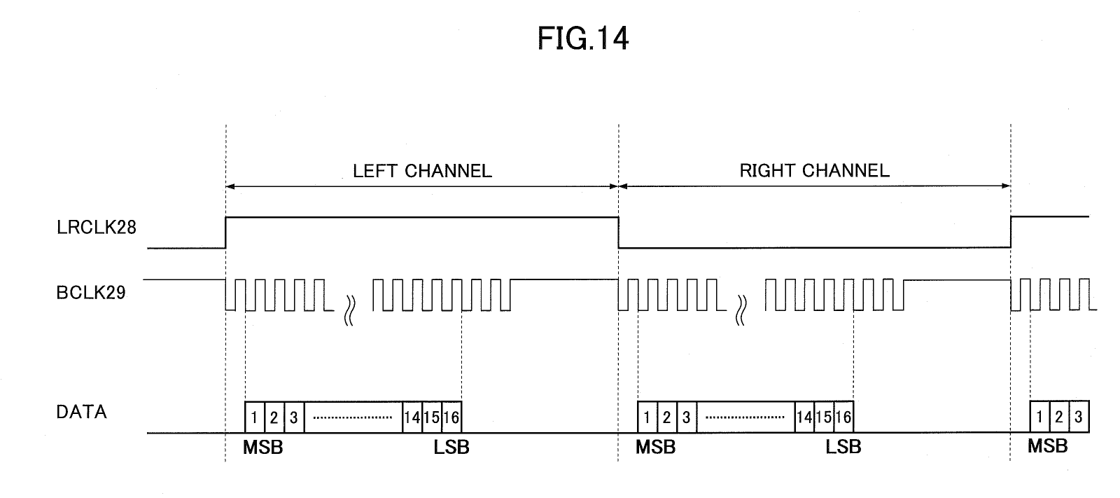

Next, transfer of audio data with a reduced number of clock pulses of the BCLK 29 is described with reference to FIG. 14.

In the examples of FIGS. 11 through 13, the number of clock pulses of the BCLK 29 in a half cycle (left channel or right channel) of the LRCLK 28 is set at a value (e.g., 32) that is greater than the effective bit width.

Here, as exemplified in FIG. 14, when the effective bit width in a half cycle of the LRCLK 28 is 16 bits, the number of clock pulses of the BCLK 29 to be counted by the BCLK number counter 13 (i.e., the third register value) may be reduced to, for example, 20 to 30 to reduce the number of clock pulses of the BCLK 29 to be output in a half cycle of the LRCLK 28. In this case, the width of the last clock pulse of the BCLK 29 is adjusted in response to the matching signal 26 that is output at early timing. This method makes it possible to virtually stop the output of clock pulses of the BCLK 29 and thereby makes it possible to reduce power consumption.

Here, it may happen that a wrong value is set as the number of clock pulses of the BCLK 29 in a half cycle of the LRCLK 28, and the clock pulses of the BCLK 29 do not fit within the sampling period. When this happens, it is not possible to adjust the width of the last clock pulse of the BCLK 20 in each half cycle of the LRCLK 28 and as a result, synchronization between the LRCLK 28 and the BCLK 29 is not maintained. To prevent this problem, the clock generator may be configured to assert the matching signal 24 indicating a change point of the LRCLK 28 only when the matching signal 26 is asserted, and may include an error detection function that detects an error when the matching signal 24 is input while the matching signal 26 is not asserted (i.e., when the last clock pulse of the BCLK 29 is not present within the half cycle of the LRCLK 28).

The clock generator of the above embodiment may be used for an information processing apparatus such as a multifunction peripheral (MFP) or a projector. Such an information processing apparatus may include an operations panel for setting the register values of the registers 14-1 through 14-3 according to the frequencies of the system CLK 21, the LRCLK 28, and the BCLK 29, and for reporting an error detected by the error detection function to the user.

An aspect of this disclosure makes it possible to provide a clock generator and an information processing apparatus that can generate an LRCLK and a BCLK, which are synchronized with each other, with reduced power consumption by using a low-frequency system clock signal.

A clock generator and an information processing apparatus according to preferred embodiments of the present invention are described above. However, the present invention is not limited to the specifically disclosed embodiments, and variations and modifications may be made without departing from the scope of the present invention.

What is claimed is:

1. A clock generator, comprising:
a first clock generating unit configured to generate a first clock signal based on a system clock signal;
a second clock generating unit configured to generate a second clock signal with a frequency higher than a frequency of the first clock signal based on the system clock signal;
a counting unit configured to count a number of clock pulses of the second clock signal in a cycle of the first clock signal; and
an adjusting unit configured to adjust a falling edge or a rising edge of the second clock signal to synchronize with a falling edge or a rising edge of the first clock signal based on an assert signal that is output when the number of clock pulses of the second clock signal counted by the counting unit reaches a predetermined value.

2. The clock generator as claimed in claim 1, further comprising:
a system clock counting unit configured to count a number of clock pulses of the system clock signal in a cycle of the second clock signal,
wherein when a last clock pulse of the second clock signal is generated immediately before the falling edge or the rising edge of the first clock signal, the adjusting unit causes the system clock counting unit to not count the number of clock pulses of the system clock signal for a predetermined period of time.

3. The clock generator as claimed in claim 2, wherein when the last clock pulse of the second clock signal is generated, the adjusting unit controls a length of an on-period or an off-period of the second clock signal such that the last clock pulse is synchronized with a change point of the first clock signal.

4. The clock generator as claimed in claim 1, wherein the counting unit is configured to count the number of clock pulses of the second clock signal in the cycle of the first clock signal up to the predetermined value.

5. The clock generator as claimed in claim 2, wherein the adjusting unit is configured to adjust the falling edge or the rising edge of the last clock pulse of the second clock signal to synchronize with the falling edge or the rising edge of the first clock signal at each half cycle of the first clock signal.

6. The clock generator as claimed in claim 5, further comprising:
an error detection unit configured to detect an error when the last clock pulse of the second clock signal is not present within the half cycle of the first clock signal.

7. The clock generator as claimed in claim 1, wherein a frequency of the system clock signal is determined based on a frequency of a clock signal used when sending and receiving audio data to and from a storage unit.

8. An information processing apparatus, comprising:
a clock generator that includes
a first clock generating unit configured to generate a first clock signal based on a system clock signal,
a second clock generating unit configured to generate a second clock signal with a frequency higher than a frequency of the first clock signal based on the system clock signal,
a counting unit configured to count a number of clock pulses of the second clock signal in a cycle of the first clock signal, and
an adjusting unit configured to adjust a falling edge or a rising edge of the second clock signal to synchronize with a falling edge or a rising edge of the first clock signal based on an assert signal that is output when the number of clock pulses of the second clock signal counted by the counting unit reaches a predetermined value.

9. The information processing apparatus as claimed in claim 8, further comprising:
an output unit configured to output audio data stored in a storage unit in synchronization with the second clock signal adjusted by the adjusting unit.
